(19) United States
(12) Patent Application Publication
(10) Pub. No.: US 2016/0180103 A1
(43) Pub. Date: Jun. 23, 2016

(54) SYSTEM, METHOD, APPARATUS, AND COMPUTER PROGRAM PRODUCT FOR ACTIVATING A SOFTWARE FUNCTIONALITY ON AN APPLIANCE

(71) Applicant: Electrolux Home Products, Inc., Charlotte, NC (US)

(72) Inventors: James Fisher, Charlotte, NC (US); Giorgio Francescangeli, Cornelius, NC (US)

(21) Appl. No.: 14/574,691

(22) Filed: Dec. 18, 2014

(51) Int. Cl. G06F 21/62

(52) U.S. Cl. CPC G06F 21/629

(57) ABSTRACT

A system, method, apparatus, and computer program product for activating a software functionality on an appliance are disclosed. A method may include receiving, via a keyboard interface operatively coupled with the appliance, a code for activating a software functionality on the appliance. The software functionality may be in a non-actuatable state. The method may further include verifying that the code is a valid code for activating the software functionality. The method may additionally include activating the software functionality such that the software functionality is in an actuatable state in response to verifying that the code is a valid code for activating the software functionality. The software functionality may remain in the non-actuatable state if an invalid code is received.

### FIELD OF THE DISCLOSURE

Aspects of the disclosure relate to appliance technology and, more particularly, to a system, method, apparatus, and computer program product for activating a software functionality on an appliance.

### BACKGROUND

In recent years, there has been rapid advancement in home appliance technology. For example, continued developments in processing technology and embedded systems technology, resulting in the availability of relatively low cost computer chips, have enabled the implementation of sophisticated computing technology in modern home appliances. The computing technology implemented in such modern home appliances has afforded appliance manufacturers more flexibility and capability to design and implement a variety of software controlled functions in appliances, thereby providing consumers with additional features not readily available on older appliances.

### SUMMARY

A system, method, apparatus, and computer program product for activating a software functionality on an appliance are disclosed. More particularly, some example embodiments provide a system including an appliance with an operatively coupled keyboard interface. The keyboard interface may be used to input a code for activating a software functionality on the appliance. In this regard, the software functionality may be in a non-actuatable state, such that the software functionality may not be actuated and used on the appliance prior to activation through input of the code. The appliance may verify that the code is valid and may activate or authorize the software functionality so that the software functionality may be placed in an actuatable state in which the software functionality may be used. Some such example embodiments may be used for activation of a new and/or upgraded software functionality that may be purchased and installed on an appliance as an upgrade for the appliance after purchase and installation of the appliance. Additionally or alternatively, some such example embodiments may be used to unlock added features that may be pre-installed in an appliance, but that an appliance owner may not have purchased rights to use at a time of purchasing the appliance.

In a first example embodiment, a method for activating a software functionality on an appliance is provided. The method may include receiving, via a keyboard interface operatively coupled with the appliance, a code for activating a software functionality on the appliance, wherein the software functionality may be in a non-actuatable state. The method may further include verifying that the code is a valid code for activating the software functionality. The method may additionally include activating the software functionality such that the software functionality is in an actuatable state in response to verifying that the code is a valid code for activating the software functionality. The software functionality may remain in the non-actuatable state if an invalid code is received.

In a second example embodiment, an appliance comprising processing circuitry operatively coupled with a keyboard interface is provided. The processing circuitry may be configured to cause the appliance to receive, via the keyboard interface, a code for activating a software functionality on the appliance, wherein the software functionality may be in a non-actuatable state. The processing circuitry may be further configured to cause the appliance to verify that the code is a valid code for activating the software functionality. The processing circuitry may additionally be configured to cause the appliance to activate the software functionality such that the software functionality is in an actuatable state in response to verifying that the code is a valid code for activating the software functionality. The software functionality may remain in the non-actuatable state if an invalid code is received.

In a third example embodiment, a computer program product is provided, which may include at least one non-transitory computer-readable storage medium having program instructions stored thereon. When executed by at least one processor implemented on an appliance, the stored program instructions may cause the appliance to perform a method including receiving, via a keyboard interface operatively coupled with the appliance, a code for activating a software functionality on the appliance, wherein the software functionality may be in a non-actuatable state. The method may further include verifying that the code is a valid code for activating the software functionality. The method may additionally include activating the software functionality such that the software functionality is in an actuatable state in response to verifying that the code is a valid code for activating the software functionality. The software functionality may remain in the non-actuatable state if an invalid code is received.

It will be appreciated that the above Summary is provided merely for purposes of summarizing some example embodiments so as to provide a basic understanding of some aspects of the disclosure. As such, it will be appreciated that the above described example embodiments are merely examples of some embodiments and should not be construed to narrow the scope or spirit of the disclosure in any way. It will be appreciated that the scope of the disclosure encompasses many potential embodiments, some of which will be further described below, in addition to those here summarized. Further, other aspects and advantages of embodiments disclosed herein will become apparent from the following detailed description taken in conjunction with the accompanying drawings which illustrate, by way of example, the principles of the described embodiments.

### BRIEF DESCRIPTION OF THE DRAWINGS

Having thus described the disclosure in general terms, reference will now be made to the accompanying drawings, which are not necessarily drawn to scale, and wherein:

FIG. 1 illustrates a system for activating a software functionality on an appliance in accordance with some example embodiments;

FIGS. 2A-2C illustrate example keyboard interfaces in accordance with some example embodiments;

FIG. 3 illustrates a block diagram of an apparatus that may be implemented on an appliance in accordance with some example embodiments;

FIG. 4 illustrates a flowchart according to an example method for activating a software functionality on an appliance in accordance with some example embodiments; and

FIG. 5 illustrates a signaling diagram of messages that may be exchanged between an appliance and a software activation server for verifying a code for activating a software functionality in accordance with some example embodiments.

### DETAILED DESCRIPTION

The present disclosure now will be described more fully hereinafter with reference to the accompanying drawings, in which some, but not all aspects of the disclosure are shown. Indeed, the disclosure may be embodied in many different forms and should not be construed as limited to the aspects set forth herein; rather, these aspects are provided so that this disclosure will satisfy applicable legal requirements. Like numbers refer to like elements throughout.

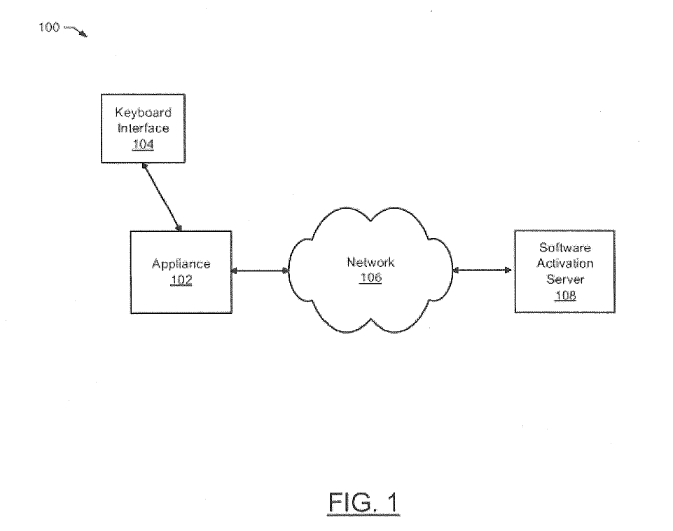

FIG. 1 illustrates a system 100 for activating a software functionality on an appliance in accordance with some example embodiments. The system 100 may include an appliance 102. The appliance 102 may be implemented as any of a variety of appliances. By way of example, in some embodiments, the appliance 102 may be a household appliance (e.g., a “white appliance”), such as by way of non-limiting example, a dishwasher, washing machine, clothes dryer, refrigerator, freezer, oven, range, cooktop, microwave oven, trash compactor, air conditioner, water heater, some combination thereof, or other household appliance.

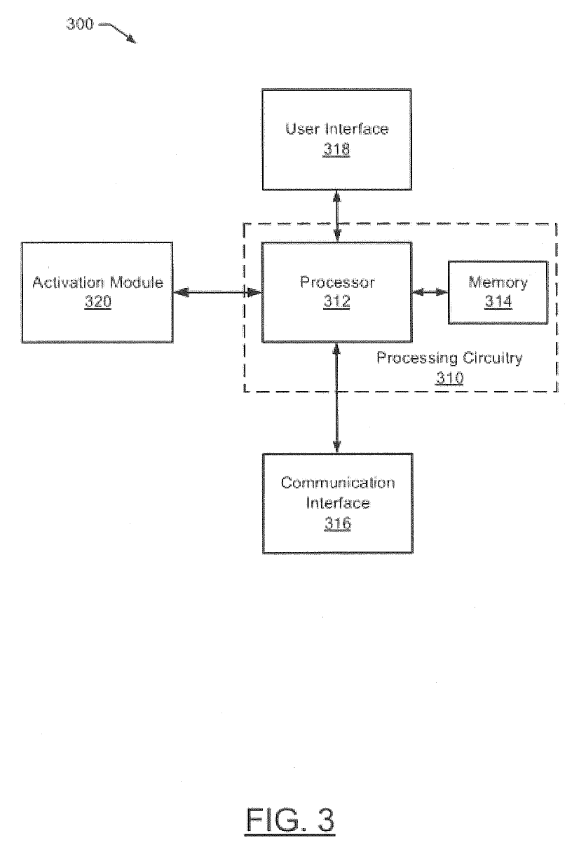

The appliance 102 may include an appropriate processor(s) and memory for storing software and/or other computer readable program instructions that may be executed by the processor(s) for carrying out at least some functionality of the appliance. In some example embodiments, aspects of the processor(s) and memory may be provided by the apparatus 300 illustrated in and described below with respect to FIG. 3.

The appliance 102 may be operatively coupled with a keyboard interface 104. The keyboard interface 104 may include a plurality of keys that may be used to enter a code for activating a software functionality in accordance with various example embodiments. The keys may include alphabetic keys, numeric keys, symbol keys, and/or some combination thereof. In some example embodiments, the keyboard interface 104 may supply a keyboard having a standardized layout of keys comprising a full set of alphabet keys for a given language, such as a QWERTY keyboard for the English language. As another example, in some embodiments, the keyboard interface 104 may comprise the 4×3 grid of keys found on a telephone, with some keys corresponding to a combination of a number and a plurality of letters. However, it will be appreciated that the keyboard interface 104 may provide a non-standard layout of key. Moreover, in some example embodiments in which the keyboard interface 104 may include alphabetic keys, the keyboard interface 104 may include keys for only a selected subset of letters in a given alphabet.

In some example embodiments, a key of the keyboard interface 104 may correspond to a single character, such as a single letter, number, symbol, or the like. Additionally or alternatively, in some embodiments, a key of the keyboard interface 104 may correspond to multiple characters, such as multiple letters; multiple numbers; multiple symbols; some combination of one or more letters, one or more numbers, and/or one or more symbols; and/or other combination of multiple characters. In some embodiments in which a key may correspond to multiple characters, a desired character may be selected through a keystroke combination, such as multiple actuations of the key, actuation of the key in combination with another key, and/or other methodology that may be used to select a desired character for a multi-character key.

It will be appreciated that a key of the keyboard interface 104 may be provided by any user actuatable input mechanism. For example, in some embodiments, one or more keys of the keyboard interface 104 may comprise individually actuatable electro-mechanical keys comprised of an electro-mechanical mechanism enabling a user to actuate a key by depressing a key such that the key is lowered via user-applied force to a point at which an electrical signal is generated through depression of the key (i.e., keys on a conventional keyboard). As another example, in some embodiments, one or more keys of the keyboard interface 104 may comprise keys displayed on a touch screen display that may be individually selected by a user touching or otherwise actuating a portion of the surface of the touch screen display corresponding to a desired key.

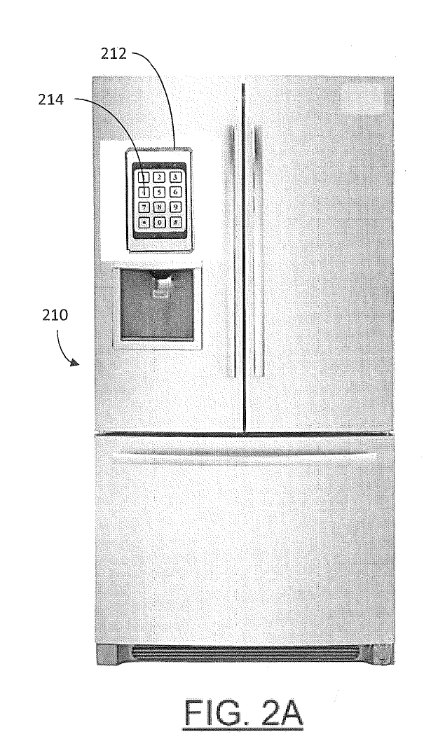

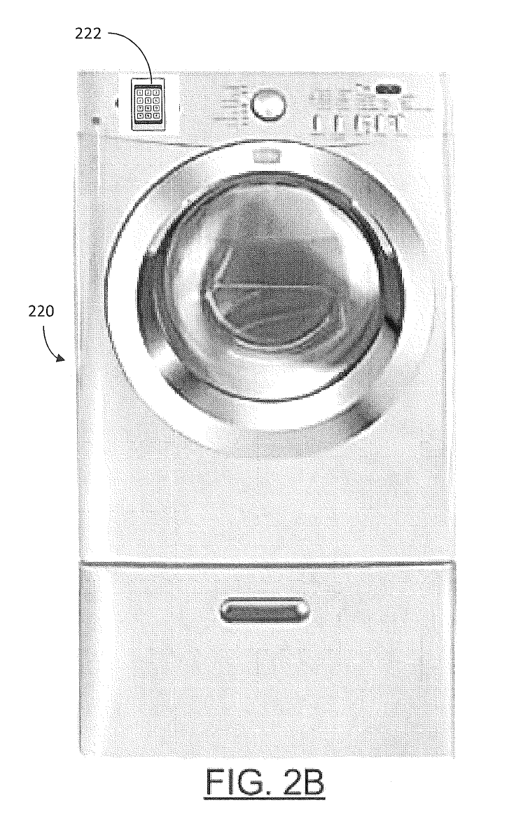

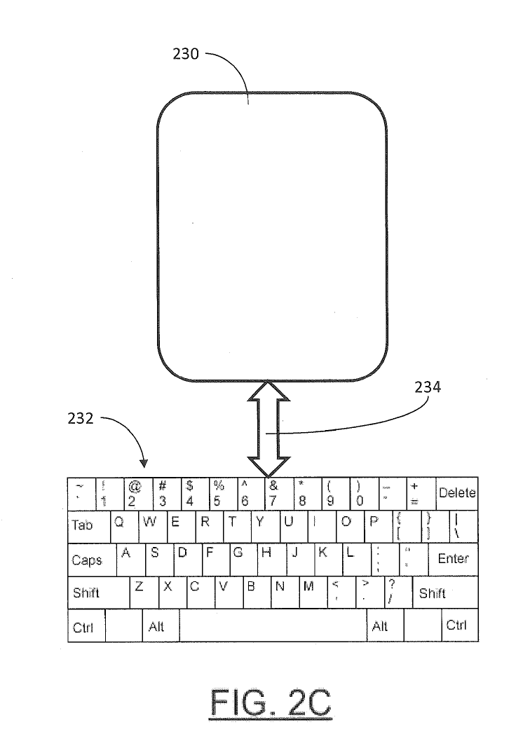

In some example embodiments, the keyboard interface 104 may be implemented on the appliance 102. For example, in some such embodiments, the appliance 102 may include an integrated touch screen display, such as may be provided by a liquid crystal display (LCD), an organic light emitting diode (OLED) display, or the like, which may be configured to display user selectable keys that may provide the keyboard interface 104. An example of such embodiments is illustrated in FIG. 2A, which displays a refrigerator 210 comprising a touch screen display 212 displayed on the exterior of a door of the refrigerator. The touch screen display 212 may display a plurality of keys 214 that may be actuated by a user to input a code for activating a software functionality on the refrigerator 210 in accordance with various example embodiments. The refrigerator 210 may accordingly comprise an embodiment of the appliance 102, and the display 212 and keys 214 may comprise an embodiment of the keyboard interface 104.

As another example, in some embodiments in which the keyboard interface 104 may be implemented on the appliance 102, a set of individually actuatable electro-mechanical keys that may be implemented on a portion of the appliance 102. For example, in FIG. 2B, the washing machine 220 may include a keypad 222 comprising keys that may be actuated by a user to input a code for activating a software functionality on the washing machine 220 in accordance with various example embodiments. In this regard, the washing machine 220 may comprise an embodiment of the appliance 102, and the keypad 222 may comprise an embodiment of the keyboard interface 104.

Alternatively, in some example embodiments, the keyboard interface 104 may comprise an external keyboard operatively coupled with the appliance 102 via a communication interface. For example, in some such embodiments, the external keyboard may comprise a dedicated hardware keyboard device. As another example, in some such embodiments, the external keyboard may be provided by a user computing device, such as a personal computer (e.g., a laptop computer, desktop computer, or other personal computer), a mobile computing device (e.g., a smart phone, mobile digital media player, tablet computer, or other mobile computing device), and/or other computing device, that may include a keyboard and/or other user interface elements that may be configured to provide aspects of a keyboard interface 104 in accordance with various example embodiments.

In embodiments in which the keyboard interface 104 is provided by an external keyboard operatively coupled with the appliance 102, the external keyboard may be operatively coupled with the appliance 102 via any appropriate communication interface that may be configured to enable communication of indications of actuated keys and/or selected characters for a code to the appliance 102. For example, in some embodiments, a physical communication interface, such as may be provided by a Universal Serial Bus (USB) connection, FireWire connection, Thunderbolt connection, PS/2 connection, RS-232 connection, and/or other physical connection that may be used to enable communication between two or more computing devices and/or between a computing device and a peripheral device. As another example, in some embodiments, a wireless communication interface between the external keyboard and the appliance 102. The wireless communication interface may, for example, be provided by a wireless local area network (WLAN), Wi-Fi Direct, Bluetooth, Zigbee, wireless USB, infrared communication, and/or other technology that may be configured to enable communication between two or more computing devices and/or between a computing device and a peripheral device.

FIG. 2C illustrates an example embodiment in which an external keyboard may be operatively coupled with an appliance 102. More particularly, FIG. 2C illustrates a dishwasher 230 coupled to a QWERTY keyboard 232 via a communication interface 234, which may comprise any physical communication interface or wireless communication interface. The dishwasher 230 may accordingly comprise an embodiment of the appliance 102, and the keyboard 232 may comprise an embodiment of the keyboard interface 104.

Returning to FIG. 1, in some example embodiments, the appliance 102 may comprise a network connected appliance that may be configured to connect to a network, such as the network 106. The network 106 may be embodied as any network, or combination of networks, which may enable two or more computing devices to communicate with each other. In this regard, the network 106 may, for example, comprise one or more wireline networks, one or more wireless networks (e.g., a cellular network, WLAN, wireless metropolitan area network, wireless wide area network, some combination thereof, or the like), or a combination thereof, and, in some example embodiments, may comprise the Internet.

In embodiments in which the appliance 102 may be configured to connect to the network 106, the connection may be provided through any of a variety of network connectivity means. For example, in some embodiments, the appliance 102 may include a communication interface supporting a connection to a home local area network (LAN), such as a WLAN, a wired LAN, a power line network, some combination thereof, or other LAN, which may, in turn, be connected to a wide area network, such as the Internet. As another example, in some embodiments, the appliance 102 may include a cellular communication interface supporting a cellular connection to the network 106. It will be appreciated, however, that any technology that may be used to connect a device to a network is contemplated within the scope of the disclosure.

In some embodiments in which the appliance 102 comprises a network connected appliance configured to access the network 106, the appliance 102 may be configured to communicate with a software activation server 108 via the network 106. However, it will be appreciated that, in some embodiments, the software activation server 108 may be omitted and, in some embodiments, the appliance 102 may not be connected to the network 106.

The software activation server 108 may comprise one or more computing devices that may be configured to provide software activation services in accordance with one or more example embodiments. The software activation server 108 may, for example, comprise one or more servers, a cloud computing infrastructure configured to provide a virtual server(s), and/or the like, which may be configured to provide software activation services for activating a software functionality on the appliance 102 in accordance with one or more example embodiments. In some example embodiments, the software activation server 108 may be embodied as a distributed computing system comprising multiple computing devices that may be in communication with each other via a network, such as the network 106.

In accordance with some example embodiments, the appliance 102 may include a software functionality (or multiple software functionalities) in a non-actuatable state (e.g., dormant state). When in a non-actuatable state, a software functionality may not be actuated and used on the appliance 102. Thus, for example, the software functionality may be locked such that a user may not invoke the software functionality.

Software functionality in a non-actuatable state may be activated (e.g., unlocked) and placed in an actuatable state through entry of a valid code (i.e., such a valid code could be an alphabetic code or an alphanumeric code, including symbols, etc., and/or may have any length or other characteristics) for activating the software functionality via the keyboard interface 104 in accordance with various example embodiments described herein. In this regard, a software functionality may be associated with one or more codes that may be used for activating the software functionality. If a valid code associated with the software functionality is entered via the keyboard interface 104, the software functionality may be activated or placed in an actuatable state. When activated, a software functionality may be unlocked such that the software functionality may be invoked or actuated by a user and/or otherwise executed by the appliance 102.

In some example embodiments, a software functionality in a non-actuatable state may be fully installed on the appliance 102, but may be locked or disabled from use until after a valid code for activating the software functionality is entered via the keyboard interface 104. As another example, in some embodiments, install code for installing the software functionality may be stored on a memory of the appliance 102 (e.g., memory 314), but the install code may not be installed such that the software functionality may be actuated until after a valid code for activating the software functionality is entered via the keyboard interface 104.

It will be appreciated that a software functionality that may be activated in accordance with various embodiments may include any software functionality that may be implemented on an appliance. For example, the software functionality may comprise a cycle of operation for the appliance 102. For example, in embodiments in which the appliance 102 is a dishwasher, the cycle of operation may comprise a dishwashing cycle. As another example, in embodiments in which the appliance 102 is a washing machine, the cycle of operation may comprise a clothes washing cycle. As a further example, in embodiments in which the appliance 102 is a clothes dryer, the cycle of operation may comprise a clothes drying cycle. As an additional example, in embodiments in which the appliance 102 is an oven or microwave, the cycle of operation may comprise a cooking cycle that may be used to prepare food for consumption.

As a further example, the software functionality may comprise a new software implemented feature that may be installed on an appliance. For example, in some embodiments in which the appliance 102 includes a display, such as an LCD display, OLED display, or the like, the software functionality may comprise software enabling the display to be used as a video display to display television programming, videos, movies, and/or other video that may be stored on the appliance 102 and/or accessible by the appliance 102, such as over the network 106.

As an additional example, the software functionality may comprise an upgrade for operating software of the appliance 102. For example, a manufacturer of the appliance 102 may issue updates for firmware and/or other operating software of the appliance 102, which may be installed on the appliance 102 and activated through input of a code via the keyboard interface 104 in accordance with various example embodiments.

In some example embodiments, the software functionality may comprise an upgrade and/or new functionality that may be downloaded to the appliance 102 via the network 106, such as from the software activation server 108 of some example embodiments. In this regard, code for implementing the software functionality may be received to the appliance 102 via the network 106 in accordance with some example embodiments. However, the software functionality associated with the downloaded code may remain in a non-actuatable state until after entry of a valid code for activating the software functionality via the keyboard interface 104.

Alternatively, in some example embodiments, the software functionality may be pre-installed on the appliance such that the software functionality may be resident on the appliance 102 in a non-actuatable state at a time of sale of the appliance by a vendor. For example, in some such embodiments, the software functionality may be sold for an additional premium over a base price for the appliance 102, such that an owner or other user of the appliance may pay for activation of the software functionality to implement an additional feature on the appliance 102, and may receive a code for activating the software functionality attendant to the payment.

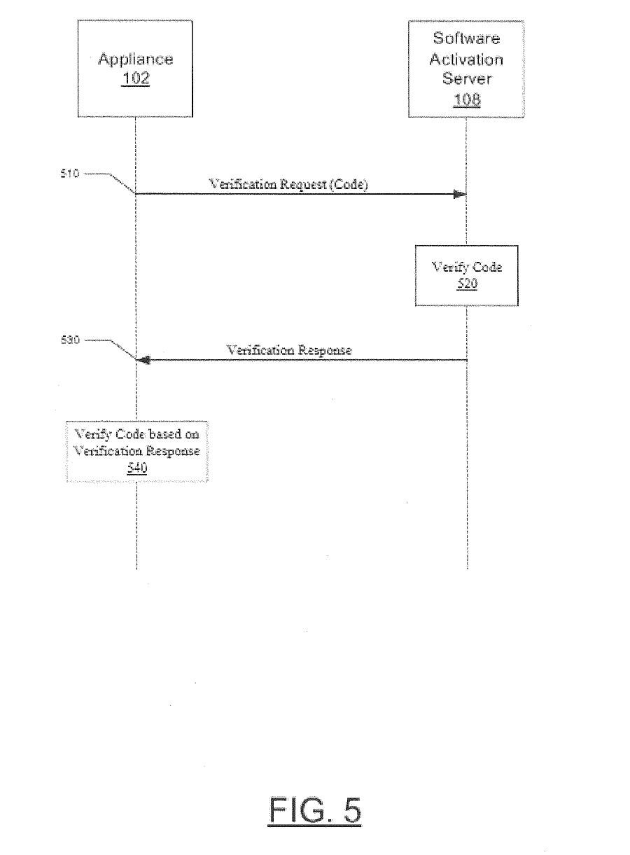

In some example embodiments including the software activation server 108, such as that illustrated in and described below with respect to FIG. 5, the software activation server 108 may be configured to facilitate verification of a code received to the appliance 102 via the keyboard interface 104. For example, the appliance 102 may be configured to send a verification request comprising the received code to the software activation server 108 via the network 106. The software activation server 108 may be configured to verify that the code corresponds to (e.g., is the same as) an activation code for the software functionality, and may send a verification response to the appliance 102 indicating whether the code is a valid code. If the code is indicated in the verification response to be a valid code, the appliance 102 may activate or render into an actuatable state the software functionality. If, however, the code is indicated in the verification response to be an invalid code, the software functionality may remain in the non-actuatable state.

Additionally or alternatively, in some example embodiments, the appliance 102 may be configured to locally verify a code received to the appliance 102 via the keyboard interface 104 without consulting the software activation server 108. For example, in some embodiments in which the software activation server 108 is omitted from the system 100 and/or in some embodiments in which the appliance 102 may not be connected to the network 106, the appliance 102 may locally verify the code. For example, the appliance 102 may store a valid activation code for a software functionality in association with the software functionality. The activation code may, for example, be securely stored such that the activation code may not be determined by accessing a memory of the appliance 102. The appliance 102 may be configured to compare the received code to the locally stored activation code to verify that the received code corresponds to (e.g., is the same as) the activation code. If the received code corresponds to the locally stored activation code (i.e., if the received code is a valid code), the appliance 102 may activate or render into an actuatable state the software functionality. However, if the received code does not correspond to the locally stored activation code (i.e., if the received code is an invalid code), the software functionality may remain in the non-actuatable state.

FIG. 3 illustrates a block diagram of an apparatus 300 that may be implemented on an appliance, such as the appliance 102, in accordance with some example embodiments. It will be appreciated that the components, devices or elements illustrated in and described with respect to FIG. 3 below may not be mandatory and thus some may be omitted in certain embodiments. Additionally, some embodiments may include further or different components, devices or elements beyond those illustrated in and described with respect to FIG. 3.

In some example embodiments, the apparatus 300 may include processing circuitry 310 that is configurable to perform functions in accordance with one or more example embodiments disclosed herein. In this regard, the processing circuitry 310 may be configured to perform and/or control performance of one or more functionalities of the appliance 102 in accordance with various example embodiments. Thus, the processing circuitry 310 may be configured to perform data processing, application execution and/or other processing and management services according to one or more example embodiments.

In some embodiments, the apparatus 300 or a portion(s) or component(s) thereof, such as the processing circuitry 310, may include one or more chipsets, which may each include one or more chips. The processing circuitry 310 and/or one or more further components of the apparatus 300 may therefore, in some instances, be configured to provide a “system on a chip” that may implement an embodiment on an integrated circuit and/or a chipset comprising one or more chips.

In some example embodiments, the processing circuitry 310 may include a processor 312 and, in some embodiments, such as that illustrated in FIG. 3, may further include memory 314. The processing circuitry 310 may be in communication with or otherwise control a communication interface 316, user interface 318, and/or activation module 320.

The processor 312 may be embodied in a variety of forms. For example, the processor 312 may be embodied as various hardware processing means, such as a microprocessor, a coprocessor, a controller or various other computing or processing devices including integrated circuits such as, for example, an ASIC (application specific integrated circuit), an FPGA (field programmable gate array), some combination thereof, or the like. Although illustrated as a single processor, it will be appreciated that the processor 312 may comprise a plurality of processors. The plurality of processors may be in operative communication with each other and may be collectively configured to perform one or more functionalities of the appliance 102. In some example embodiments, the processor 312 may be configured to execute instructions that may be stored in the memory 314 and/or that may be otherwise accessible to the processor 312. As such, whether configured by hardware or by a combination of hardware and software, the processor 312 may be capable of performing operations according to various embodiments, while configured accordingly.

In some example embodiments, the memory 314 may include one or more memory devices. Memory 314 may include fixed and/or removable memory devices. In some embodiments, the memory 314 may provide a non-transitory computer-readable storage medium that may store computer program instructions that may be executed by the processor 312. In this regard, the memory 314 may be configured to store information, data, applications, instructions and/or the like for enabling the apparatus 300 to carry out various functions in accordance with one or more example embodiments. For example, the memory 314 may store code for implementing one or more software functionalities that may be activated in accordance with various example embodiments. In some embodiments, the memory 314 may be in communication with one or more of the processor 312, communication interface 316, user interface 318, and activation module 320 via one or more buses for passing information among components of the apparatus 300.

The apparatus 300 may further include a communication interface 316. The communication interface 316 may be configured to enable the appliance 102 to communicate with one or more further computing devices and/or networks. For example, the communication interface 316 of some example embodiments may be configured to enable the appliance 102 to connect to the network 106. As another example, in some embodiments in which the keyboard interface 104 may comprise an external keyboard in operative communication with the appliance 102 via a communication interface, the communication interface 316 may be configured to enable communication between the appliance 102 and the external keyboard device, such as via a physical and/or wireless communication link. The communication interface 316 may accordingly include one or more interface mechanisms for enabling communication with other devices and/or networks. As such, the communication interface 316 may include, for example, an antenna (or multiple antennas) and supporting hardware and/or software for enabling communications with a wireless communication network (e.g., a cellular network, Wi-Fi, WLAN, and/or the like) and/or a communication modem or other hardware/software for supporting communication via cable, digital subscriber line (DSL), USB, FireWire, Ethernet, one or more optical transmission technologies, and/or other wireline networking methods. As a further example, the communication interface 316 may be configured to support wireless communication with another device, such as an external keyboard device, via Wi-Fi direct, a Bluetooth connection, Zigbee connection, wireless USB connection, near field communication (NFC), radio frequency identification (RF-ID) communication, Infrared Data Association (IrDA)-compliant connection and/or other infrared connection, and/or other wireless connection. Additionally or alternatively, the communication interface 316 of some example embodiments may be configure to support a direct wired connection with another device, such as an external keyboard device. Thus, for example, the communication interface 316 may be configured to support a USB connection, FireWire connection, Thunderbolt connection, a serial connection, a parallel connection, Ethernet, and/or other wired connection that may be used to interface two or more computing devices and/or computing device and a peripheral device.

In some example embodiments, the apparatus 300 may include the user interface 318. It will be appreciated, however, that in some example embodiments, one or more aspects of the user interface 318 may be omitted, and in some embodiments, the user interface 318 may be omitted entirely. The user interface 318 may be in communication with the processing circuitry 310 to receive an indication of a user input and/or to provide an audible, visual, mechanical, or other output to a user. As such, the user interface 318 may include, for example, a keyboard, a mouse, a joystick, a display, a touch screen display, a microphone, a speaker, one or more biometric input devices (e.g., a visual or sensorial tracing device that may track body part or eye movements), and/or other input/output mechanisms. In embodiments where the user interface 318 comprises a touch screen display, the user interface 318 may additionally be configured to detect and/or receive an indication of a touch and/or other movement gesture or other input to the display. In some example embodiments in which the keyboard interface 104 is implemented on the appliance 102, the user interface 318 may be configured to provide aspects of the keyboard interface 104, such as via a keyboard and/or touch screen display that may be included in the user interface 318.

The apparatus 300 may further include activation module 320. The activation module 320 may be embodied as various means, such as circuitry, hardware, a computer program product comprising a computer readable medium (for example, the memory 314) storing computer readable program instructions executable by a processing device (for example, the processor 312), or some combination thereof In some embodiments, the processor 312 (or the processing circuitry 310) may include, or otherwise control the activation module 320. The activation module 320 may be configured to perform operations for activating a software functionality in response to receipt of a code via the keyboard interface 104. For example, in some embodiments, the activation module 320 may be configured to verify that a received code is valid by comparing the received code to a locally stored activation code and/or by sending a verification request to the software activation server 108 and evaluating a verification response that may be received from the software activation server 108 in response to the verification request. If a received code is determined by the activation module 320 to be a valid code for activating or render into an actuatable state a software functionality, the activation module 320 may be configured to activate the software functionality such that it is in an actuatable state.

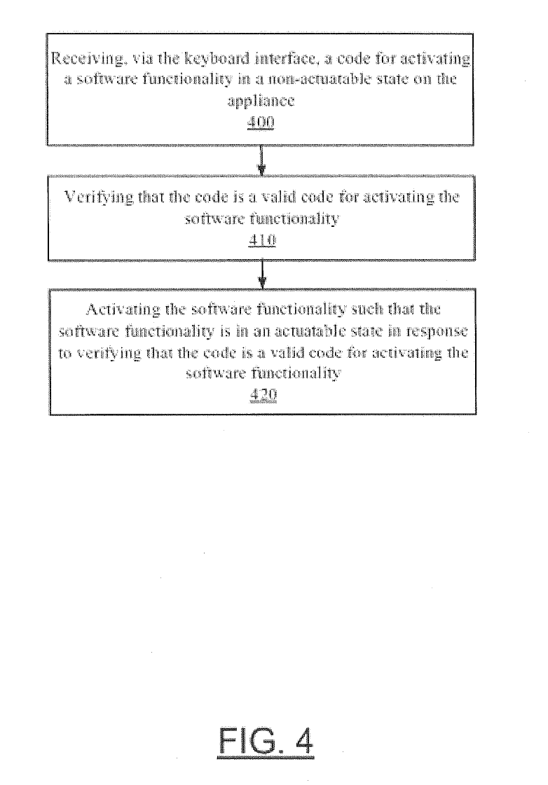

FIG. 4 illustrates a flowchart according to an example method for activating a software functionality in accordance with some example embodiments. In this regard, FIG. 4 illustrates operations that may be performed by an appliance, such as appliance 102, in accordance with various example embodiments. One or more elements of the apparatus 300, such as one or more of processing circuitry 310, processor 312, memory 314, communication interface 316, user interface 318, or activation module 320 may, for example, provide means for performing one or more of the operations illustrated in and described with respect to FIG. 4.

Operation 400 may include the appliance 102 receiving, via the keyboard interface 104, a code for activating or otherwise render into an actuatable state a software functionality that is in a non-actuatable state on the appliance.

In some example embodiments, a user of the appliance 102 may select to enter a software activation mode and/or otherwise select an option to activate the software functionality by providing input to the user interface 318 prior to inputting the code. As such, the appliance 102 may be configured to expect and/or otherwise be provided with a context for interpreting the code as a code for requesting activation of a user selected software functionality.

Operation 410 may include the appliance 102 verifying that the code that may be received in operation 410 is a valid code for activating or render into an actuatable state the software functionality. For example, in some embodiments, operation 410 may include comparing the received code to a locally stored activation code associated with the software functionality. As another example, in some embodiments, such as that illustrated in and described below with respect to FIG. 5, operation 410 may include the appliance 102 sending a verification request including the received code to the software activation server 108 for verification, and verifying the code based on a verification response that may be received from the software activation server 108 in response to the verification request.

Operation 420 may include the appliance 102 activating the software functionality such that the software functionality is in an actuatable state in response to verifying that the code is a valid code for activating the software functionality. If, however, an invalid code for activating the software functionality is received in operation 400, the software functionality may remain in the non-actuatable state. In this regard, the verification operation of operation 410 may include a determination of whether the received code is a valid code, and operation 420 may be omitted if an invalid code is received.

In some example embodiments, if an invalid code is received, the appliance 102 may be configured to provide an error indication (e.g., an audible and/or visual indication) via the user interface 318. In some instances, the user may be prompted to reenter the code in case the user misentered one or more characters of the code.

FIG. 5 illustrates a signaling diagram of messages that may be exchanged between the appliance 102 and the software activation server 108 for verifying a code for activating or render into an actuatable state a software functionality in accordance with some example embodiments. More particularly, FIG. 5 illustrates signaling and operations that may be performed by the appliance 102 and software activation server 108 to enable performance of operation 410 by the appliance 102 in accordance with some example embodiments.

With reference to FIG. 5, operation 510 may include the appliance 102 sending a verification request including a copy of a received code (e.g., the code that may be received in operation 400) to the software activation server 108. The verification request may further include an indication of a software functionality for activation.

Operation 520 may include the software activation server 108 verifying that the code that may be received in the verification request is a valid code for activating or render into an actuatable state the software functionality. For example, operation 520 may include looking up an activation code associated with the software functionality and/or with a user/owner of the appliance 102 and comparing the received code to the activation code associated with the software functionality to verify that the received code corresponds to (e.g., is the same as or is indicative of) the activation code.

The software activation server 108 may generate a verification response indicating the finding from operation 520 (e.g., indicating either that the code is valid or invalid). The software activation server 108 may send the verification response to the appliance 102, as illustrated in operation 530.

Operation 540 may include the appliance 102 verifying the received code based on the verification response. In this regard, the appliance 102 may determine whether the verification response has indicated that the code is valid, or has indicated that the code is invalid. If the verification response indicates that the code is valid, the appliance 102 may activate or render into an actuatable state the software functionality (e.g., through performance of operation 420). If, however, the verification response indicates that the code is invalid, the appliance 102 may maintain the software functionality in the non-actuatable state.

It will be understood that each block of the flowchart in FIG. 4, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which may embody the procedures described herein may be stored by one or more memory devices of a computing device, such as the appliance 102, and executed by a processor (e.g., processor 312) in the computing device. In some embodiments, the computer program instructions comprising the computer program product(s) which embody the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored, such that the one or more computer-readable memories can direct a computer or other programmable apparatus to function in a particular manner, and such that the computer program product comprises an article of manufacture which implements the function specified in the flowchart block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s). Accordingly, blocks of the flowchart support combinations of means for performing the specified functions. It will also be understood that one or more blocks of the flowcharts, and combinations of blocks in the flowchart, may be implemented by special purpose hardware-based computer systems which perform the specified functions, or combinations of special purpose hardware and computer program product(s).

Moreover, it will be appreciated that the ordering of blocks and corresponding method operations within the flowchart is provided by way of non-limiting example in order to describe operations that may be performed in accordance some example embodiments. In this regard, it will be appreciated that the ordering of blocks and corresponding method operations illustrated in the flowchart are non-limiting, such that the ordering of two or more block illustrated in and described with respect to the flowchart may be changed and/or method operations associated with two or more blocks may be at least partially performed in parallel in accordance with some example embodiments. Further, in some embodiments, one or more blocks and corresponding method operations illustrated in and described with respect to the flowchart may be optional, and may be omitted.

Functions in accordance with the above described embodiments may be carried out in many ways. In this regard, any suitable means for carrying out each of the functions described above may be employed to carry out various embodiments. In some embodiments, a suitably configured processor (e.g., processor 312) may provide all or a portion of the elements. In other embodiments, all or a portion of the elements may be configured by and operate under control of a computer program product. The computer program product for performing the methods of various embodiments includes at least one computer readable storage medium having computer readable program code stored thereon. The computer readable medium (or media) may, for example, be embodied as and/or otherwise include the memory 314. However, it will be appreciated that a computer program product in accordance with various example embodiments may include any data storage device (e.g., a non-transitory computer readable storage medium) that can store data, which can be thereafter read by a computer system. Examples of the computer readable storage media include hard drives, network attached storage (NAS), read-only memory, random-access memory, one or more digital versatile disc (DVDs), one or more compact disc read only memories (CD-ROMs), one or more compact disc-recordable discs (CD-Rs), one or more compact disc-rewritable discs (CD-RWs), one or more Blu-Ray discs, magnetic tapes, flash memory, some combination thereof, and/or other optical and non-optical data storage devices. Some example embodiments may additionally or alternatively use computer readable storage media distributed over a network coupled computer system such that the computer readable code may be stored and executed in a distributed fashion.

It will be appreciated that the various aspects, embodiments, implementations and features of the described embodiments may be used separately or in any combination. Various aspects of the described embodiments may be implemented via computer program product, which may be provided via a computer-readable medium, such as memory 314, storing software and/or firmware, hardware, or a combination of hardware and software.

Many modifications and other embodiments of the inventions set forth herein will come to mind to one skilled in the art to which these disclosed embodiments pertain having the benefit of the teachings presented in the foregoing descriptions and the associated drawings. Therefore, it is to be understood that embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure. In this regard, for example, different combinations of elements and/or functions than those explicitly described above are also contemplated within the scope of the disclosure. Although specific terms are employed herein, they are used in a generic and descriptive sense only and not for purposes of limitation.

It should be understood that although the terms first, second, etc. may be used herein to describe various steps or calculations, these steps or calculations should not be limited by these terms. These terms are only used to distinguish one operation or calculation from another. For example, a first calculation may be termed a second calculation, and, similarly, a second step may be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

1. A method for activating a software functionality on an appliance, the method comprising:
receiving, via a keyboard interface operatively coupled with the appliance, a code for activating a software functionality pre-installed on the appliance in a non-actuatable state; and in response to receipt of the code,
comparing, by a processor of the appliance, the code to a locally stored activation code associated with the software functionality, and verifying that the code is a valid code for activating the software functionality based thereon; and
activating the software functionality such that the software functionality is in an actuatable state in response to verifying that the code is a valid code for activating the software functionality, wherein the software functionality remains in the non-actuatable state if an invalid code is received.

2-5. (canceled)

6. The method of claim 1, further comprising:
receiving, via a user interface associated with the appliance, a user selection to activate the software functionality prior to receiving the code.

7. The method of claim 1, wherein the software functionality comprises a cycle of operation for the appliance.

8. The method of claim 1, wherein the software functionality comprises an upgrade for operating software of the appliance.

9. The method of claim 1, wherein the keyboard interface comprises one of a set of hardware keys implemented on the appliance or a keyboard displayed on a touch screen display implemented on the appliance.

10. The method of claim 1, wherein the keyboard interface comprises an external keyboard operatively coupled with the appliance via a communication interface.

11. An appliance comprising processing circuitry operatively coupled with a keyboard interface, wherein the processing circuitry is configured to cause the appliance to at least:
receive, via the keyboard interface, a code for activating a software functionality pre-installed on the appliance in a non-actuatable state; and in response to receipt of the code,
compare the code to a locally stored activation code associated with the software functionality, and verify that the code is a valid code for activating the software functionality based thereon; and
activate the software functionality such that the software functionality is in an actuatable state in response to verifying that the code is a valid code for activating the software functionality, wherein the software functionality remains in the non-actuatable state if an invalid code is received.

12-15. (canceled)

16. The appliance of claim 11, wherein the software functionality comprises one or more of a cycle of operation for the appliance or an upgrade for operating software of the appliance.

17. The appliance of claim 11, wherein the keyboard interface comprises one of a set of hardware keys implemented on the appliance, a keyboard displayed on a touch screen display implemented on the appliance, or an external keyboard operatively coupled with the appliance via a communication interface.

18. A computer program product comprising at least one non-transitory computer readable storage medium having computer readable program instructions stored thereon, the computer readable program instructions comprising program instructions which, when executed by at least one processor implemented on an appliance, cause the appliance to perform a method comprising:
receiving, via a keyboard interface operatively coupled with the appliance, a code for activating a software functionality pre-installed on the appliance in a non-actuatable state; and in response to receipt of the code,
comparing the code to a locally stored activation code associated with the software functionality, and verifying that the code is a valid code for activating the software functionality based thereon; and
activating the software functionality such that the software functionality is in an actuatable state in response to verifying that the code is a valid code for activating the software functionality, wherein the software functionality remains in the non-actuatable state if an invalid code is received.

19. (canceled)

20. (canceled)
